(19) United States
(12) Patent Application Publication
(10) Pub. No.: US 2004/0117166 A1
(43) Pub. Date: Jun. 17, 2004

(54) Logic arrangement, system and method for automatic generation and simulation of a fieldbus network layout

(76) Inventor: Cesar Cassiolato, Ribeirao Preto (BR)

Correspondence Address: BAKER & BOTTS, 30 ROCKEFELLER PLAZA, NEW YORK, NY, 10112

(21) Appl. No.: 10/316,720

(22) Filed: Dec. 11, 2002

(51) Int. Cl. G06F 17/50; G06G 7/62

(52) U.S. Cl. 703/13; 716/8

(57) ABSTRACT

The present invention relates generally to a logic arrangement, system and method which aid in the design of a fieldbus network. In particular, the logic arrangement, system and method facilitate a generation of a fieldbus network layout in accordance with a fieldbus network design and the design rules of the particular fieldbus protocol. Further, the logic arrangement, system and method can facilitate a computer simulation of an operation of a designed fieldbus network prior to its physical implementation.

### FIELD OF THE INVENTION

The present invention relates generally to a logic arrangement, system and method which may be used for a fieldbus network. In particular, the present invention is directed to a logic arrangement, system and method which facilitate the generation of a fieldbus network layout, and allow for a simulation of a fieldbus network design.

### BACKGROUND OF THE INVENTION

Process control systems provide a way for ensuring efficiency, reliability, profitability, quality and safety in a process/product manufacturing environment. Such process control systems can be used for automation, monitoring and control in a wide array of industrial applications for many industry segments, including textiles, glass, pulp and paper, mining, building, power, sugar, food and beverage, oil and gas, steel, water and wastewater, chemicals, etc.

The conventional process control systems generally include a plurality of field devices positioned at various locations on, e.g., a 4-10 mA analog network. These devices include measurement and control devices (such as temperature sensors, pressure sensors, flow rate sensors, control valves, switches, etc., or combinations thereof). Recently, a number of protocols were introduced which provide a digital alternative to conventional control systems, and which utilize “smart” field devices. These “smart” field devices can provide the same functionality as the conventional devices listed above, and additionally include one or more microprocessors incorporated therein, one or more memories, and other components. Such smart field devices may be communicatively coupled to each other and/or to a central processor using an open smart communications protocol. These protocols (e.g., Foundation® Fieldbus protocol) have been widely used in manufacturing and process plants. Many of such protocols have been developed for non-process control environments, such as automobile manufacturing or building automation, and were later adapted to be used for process control. Some of the more widely used fieldbus protocols include Hart@, Profibus®, Foundation® Fieldbus, Controller Area Network protocols, etc.

These protocols differ in several respects. Some protocols can be referred to as “open” to varying degrees, i.e., they can be interoperable with devices and software arrangements produced by a multitude of vendors. Other protocols are only “partially-open,” meaning that even though they may be compatible with field devices produced by a variety of vendors, these partially open protocols require some type of proprietary control hardware or application for configuration and control of the network. Foundation® Fieldbus is considered to be one open fieldbus protocol, since it does not require any such proprietary control application. Profibus PA is an example of a partially-open fieldbus network protocol, since it is based on a partially proprietary system. Additionally, the various fieldbus protocols differ in their physical layer specifications. For example, some provide higher maximum data transfer rates than others, allow longer wiring runs, provide for more field devices to be attached to a particular segment of the network, etc.

Various fieldbus network protocols differ in the way they distribute network control functions. For example, in the case of the Foundation® Fieldbus protocol, a control of the network is provided to the field devices. Although this scheme utilizes more complex and costly field devices, it decreases the dependency on a central host and decreases costly wiring run. Alternatively, other systems focus on a more traditional centralized control model, which facilitates the use of less complex, and therefore less expensive field devices.

Fieldbus process control systems also may include a controller communicatively coupled to each of the smart field devices using an open, “smart” communications protocol, and a server communicatively coupled to the controller using, for example, an Ethernet connection. Moreover, this controller may include a processor, and can receive data from each of the “smart” field devices. These “smart” field devices preferably include a processor for performing certain functions thereon, without the need to use the central host for such functions. The amount of processing by the centralized host generally depends on the type of a control application and protocol used.

During fieldbus network operation, each smart field device may perform a function within the control process. For example, a temperature sensor may measure a temperature of a liquid, a pressure sensor may measure pressure within a container, a flow rate sensor may measure a flow rate of a liquid, etc. Similarly, valves and switches may open to provide or increase the flow rate of the liquid, or close to stop the flow or decrease the flow rate of the liquid. After the smart field devices obtain measurements of various process parameters or after the smart field devices open or close the valves or switches, these devices may communicate with the controller. For example, the smart field devices may forward field data to the controller, and the controller can implement a control procedure based on the received data. Additionally, the field data may be recorded in a centralized or distributed database.

A fieldbus network may be configured and controlled using various known software configuration tools which implement a control strategy for the entire network and/or a particular portion of the network. For certain partially-open protocols, the software configuration tools may include proprietary software. In one exemplary process control system, a process control for a tank that can be used to pasteurize a beverage may utilize several different measurement and control devices, all of which can be communicatively coupled to the fieldbus network. This portion of the fieldbus network may be controlled using the control strategy. Several software configuration tools that may be used to implement these fieldbus control strategies are known in the art, and provide a wide range of functionality to users and designers of the fieldbus process control systems.

The specifications for the various fieldbus protocols also specify a complex set of rules according to which the physical layout of a fieldbus is generally designed. These rules include such parameters as minimum and maximum voltages and currents, power consumption, maximum segment and spur lengths for the different communication/network topologies (e.g., star, daisy-chain, etc.), maximum number of field devices which may be connected to the network, etc. Additionally, a variety of other engineering and design principles and environmental issues can be considered when designing the fieldbus network, thus further increasing the complexity of the design process. A variety of intensive calculations are generally performed to design the physical layout of the network. Furthermore, even minor modifications to the network configuration (including a placement of a new device on a segment) could possibly require complete re-calculations of the loads, processing strain, etc. so as to maintain a conformity with the protocol standard. In conventional fieldbus network designs, a significant amount of these calculations are likely performed in a manual manner.

However, there is no arrangement, system and method which assists in the physical layout of the fieldbus network in accordance with the requirements provided in the specifications and requirements for the various fieldbus network protocols (and other design guidelines). Additionally, there exists no arrangement, system and method which promotes the operation of the fieldbus network prior to its physical implementation.

### SUMMARY OF THE INVENTION

100111 Therefore, a need has arisen to provide a system and method which may automatically generate a fieldbus network layout in accordance with design rules which can be based on the physical layer guidelines for the particular protocol. In addition, there exists a need for an arrangement that can simulate the operation of a fieldbus network before its physical implementation.

According to an exemplary embodiment of the present invention, a logic arrangement, system and method are provided which facilitate an automatic generation of a layout for a fieldbus network in accordance with physical layer guidelines for the particular protocol, and also allow for an analysis of the network prior to its physical implementation. In such embodiment at least one fieldbus network design rule, and data associated with one or more components of the fieldbus network can be obtained. Then, an association of the components can be automatically generated based on the data and the at least one fieldbus network design rule. The association of the components may be a fieldbus network layout. In addition, it is possible to select a particular fieldbus network protocol, which may be Foundation® Fieldbus, Profibus, Hart, Interbus, Control Area Network, or another fieldbus protocol.

Another exemplary embodiment according to the present invention provides a logic arrangement, system and method for simulating the operation of a fieldbus network. In this embodiment, the operation of the fieldbus network can be simulated in accordance with the obtained fieldbus network operation rules and the retrieved data. In addition, it is possible to again select a particular fieldbus network protocol, which may be Foundation Fieldbus, Profibus, Hart, Interbus, Control Area Network, or some other fieldbus protocol.

One of the advantages of the logic arrangement, system and method of the present invention is that the fieldbus network layout may automatically be generated in accordance with the physical layer specification for the particular protocol, thus allowing for a conformity with the specification at such physical layer. Another advantage of the present invention is that an efficient and optimized fieldbus network topology can be provided for a given fieldbus design. Further, the present invention can facilitate a simulation of an actual operation of the newly-designed fieldbus network, so as to afford an opportunity to perform additional fault detection and correction prior to the implementation of the physical fieldbus network. Such simulation potentially prevents costly design modification after the system installation has been completed. Additionally, such simulation can assist in the configuration of control loops in the fieldbus network control strategy.

### BRIEF DESCRIPTION OF THE DRAWINGS

For a more complete understanding of the present invention, the needs satisfied thereby, and the objects, features, and advantages thereof, reference now is made to the following descriptions taken in connection with the accompanying drawings.

FIG. 1 is an illustration of an exemplary embodiment of a fieldbus network/system.

FIG. 2 is an exemplary embodiment of a fieldbus tree-type topology.

FIG. 3 is an exemplary embodiment of a fieldbus bus-type topology.

FIG. 4 is a flow diagram of an exemplary embodiment of a method for automatically generating a layout for a fieldbus network according to the present invention.

FIG. 5A is a block-diagram illustration of an exemplary fieldbus design layout that can be generated by the logic arrangement, system and method according to the present invention.

FIG. 5B is a block-diagram illustration of another exemplary fieldbus design that can be generated by the logic arrangement, system and method according to the present invention.

FIG. 6 is an illustration of an exemplary design of a fieldbus network that can be generated by the logic arrangement, system and method automatically according to the present invention.

FIG. 7 is a flow diagram of another exemplary embodiment of the claimed method according to the present invention for simulating an operation of a fieldbus network.

FIG. 8 is an exemplary screenshot sample generated by an embodiment of the logic arrangement according to the present invention.

### DETAILED DESCRIPTION

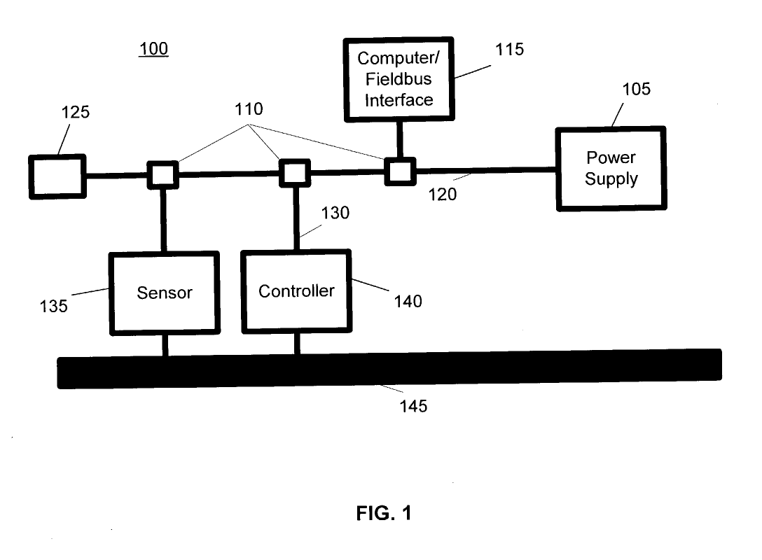

Exemplary embodiments of the present invention and their advantages may be understood by referring to FIGS. 1-8, like numerals being used for like corresponding parts in the various drawings.

FIG. 1 shows an exemplary embodiment of a fieldbus network system 100 which may include a power supply 105 coupled to the fieldbus which is composed of long distance trunks 120 and shorter distance spurs 130. A computer 115 containing interface arrangements (or network cards) may be communicatively coupled to the fieldbus network to perform, e.g., configuration, monitoring and control functions. Depending on the type of the fieldbus protocol being used, the interface connecting the interface arrangements of the computer 115 to the fieldbus network may be a proprietary interface (such as provided for Profibus fieldbus networks), or an open interface which is non-vendor specific (such as provided in Foundation® Fieldbus networks). The fieldbus network can also have connected thereto one or more terminators 125 and one or more field devices which may be a sensor 135, an actuator 140, etc. These field devices 135, 140 may be used to monitor and control, for example, the flow of a liquid through a conduit 145. In one exemplary application, the sensor 135 may monitor the flow rate of the liquid through the conduit 145, and the actuator 140 may open/close a valve to increase/decrease the flow rate in response to the monitoring of the sensor 135. Depending on a fieldbus design or configuration that can be provided by a user, a layout generation tool (e.g., software) according to the present invention may select a particular network topology from a variety of topologies and options to determine which of them provides the most efficient fieldbus network according to the design that may be specified by the user and the physical layer specification for a particular fieldbus network protocol.

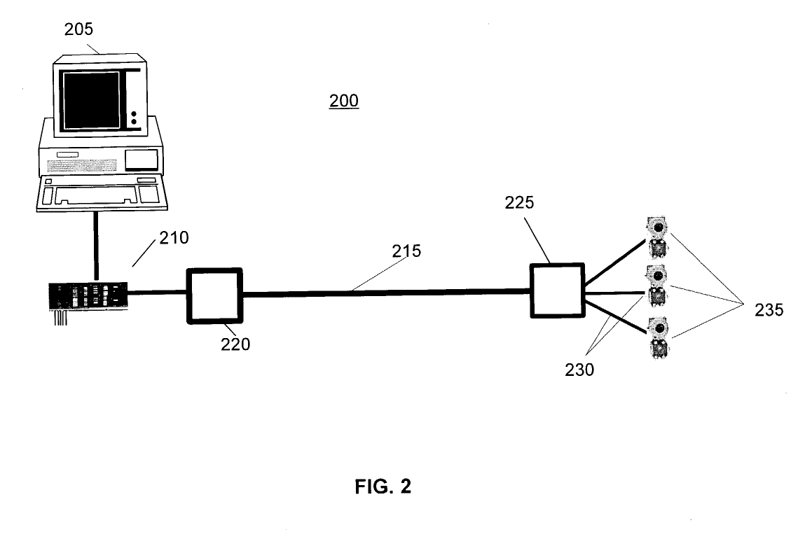

Referring to FIG. 2, the exemplary embodiment of the fieldbus network 200 that can be generated according to the present invention is depicted that includes a tree-type topology. At least one processing arrangement (e.g., a computer) 205 resides on a Profibus PA fieldbus network 200 for providing configuration, monitoring and control functions. In the exemplary embodiment of the network 200 illustrated in FIG. 2, a proprietary Profibus PA interface arrangement/card 210 and a data link coupler 220 are shown to be used to interface the computer 205 to such network 200. A trunk 215 can be provided in this network 200 which can be a long distance wire run which extends from the control components to a terminator 225. A plurality of spurs 230 are preferably coupled to the terminator 225, each of which can be coupled to one or more field devices 235.

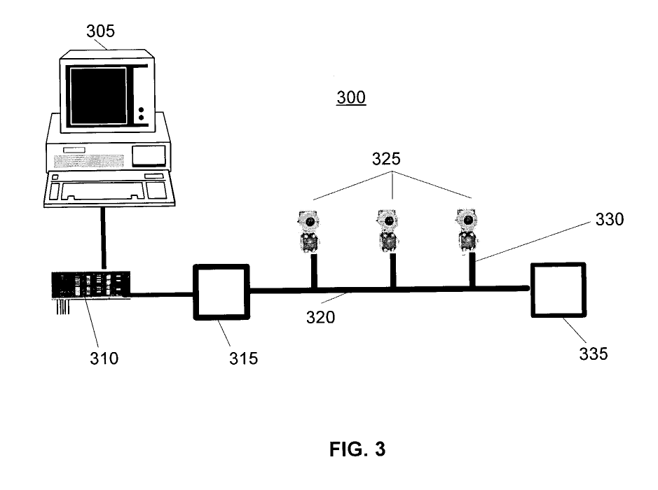

FIG. 3 shows another exemplary embodiment of the fieldbus network 300 which is similar to the Profibus fieldbus network of FIG. 2. However, the network 300 has a bus-type topology instead of a tree-type topology. In the Profibus PA fieldbus network 300, at least one computer 305 is provided thereon to effect configuration, monitoring and control functions. A proprietary Profibus PA interface arrangement/card 310 and a data link coupler 315 are used to interface a computer 305 to the Profibus PA fieldbus network 300. Also, a trunk 320 (similar to the trunk of FIG. 2) extends from the control components to a terminator 335. A plurality of shorter length connection arrangements (e.g., spurs) 330 are connected to the trunk 320, each of which connects one or more field devices 325 to the trunk 320.

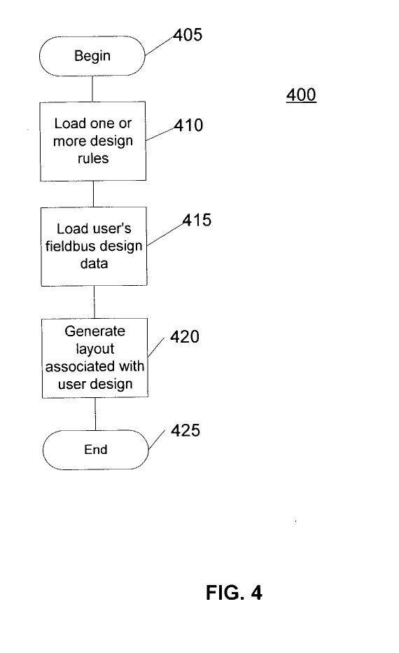

FIG. 4 illustrates a top level flow diagram of an exemplary embodiment of a method according to the present invention which can implement an automatic fieldbus layout algorithm. In step 410, one or more design rules are obtained by the software arrangement (e.g., loaded into its memory). The design rules may be defined or obtained from different sources, e.g., the physical layer specification for the particular protocol, generally accepted principles in engineering and design of fieldbus networks, electrical characteristics of widely used fieldbus devices, etc. These design rules may be provided to an automatic fieldbus layout generation arrangement according to the present invention in a variety of ways. In one exemplary embodiment of the method of the present invention, the selected fieldbus network protocol may not be known by the software arrangement. Thus, the user manually provides the design rules to the software arrangement in a particular format. In yet another exemplary embodiment of the present invention, a database may be used to provide such rules. In particular, the database contains predefined design rules for a plurality of known fieldbus network protocols. Additionally, if the user specifies a new type of fieldbus network protocol which is not listed in the database or prefers to configure a custom fieldbus protocol, the new settings may be recorded in the database for a future use.

Then the user can provide a fieldbus network design 415, the layout for which is preferably automatically generated in step 420 by the software arrangement according to the present invention. The user's fieldbus network design provided in step 415 may include, e.g., the field devices to be used, a layout of the plant, physical locations where some of the fieldbus devices are to be mounted, etc. The amount of information required may vary depending on constraints of available resources. The logic arrangement, system and method according to the present invention may then generate a layout (in step 420) for the fieldbus network design according to the loaded design rules, which again may be extensions of the physical layer requirements established in the particular (e.g., selected) fieldbus network protocol. In a variation of the exemplary embodiment of the present invention, it is possible to automatically detect which type of fieldbus protocol is to be used based on the fieldbus network design provided by the user. In such case, the loading of the design rules of step 410 illustrated in FIG. 4 may be automated, since it may be possible to automatically load the design rules for the particular type of fieldbus network based on the determination of the particular fieldbus protocol.

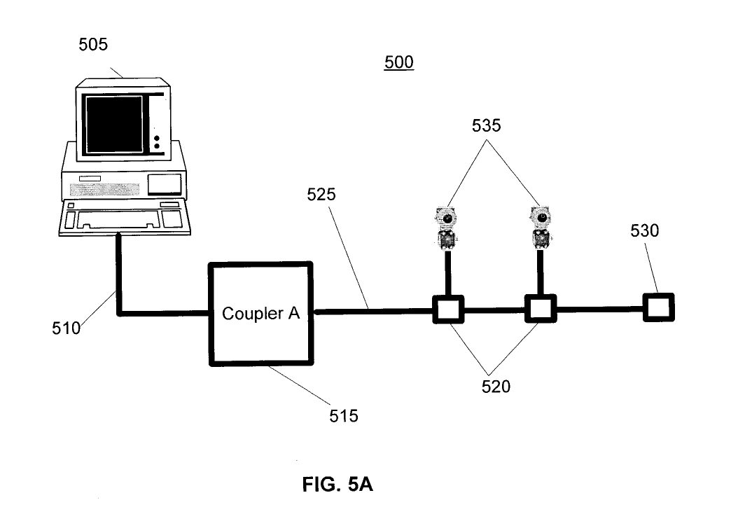

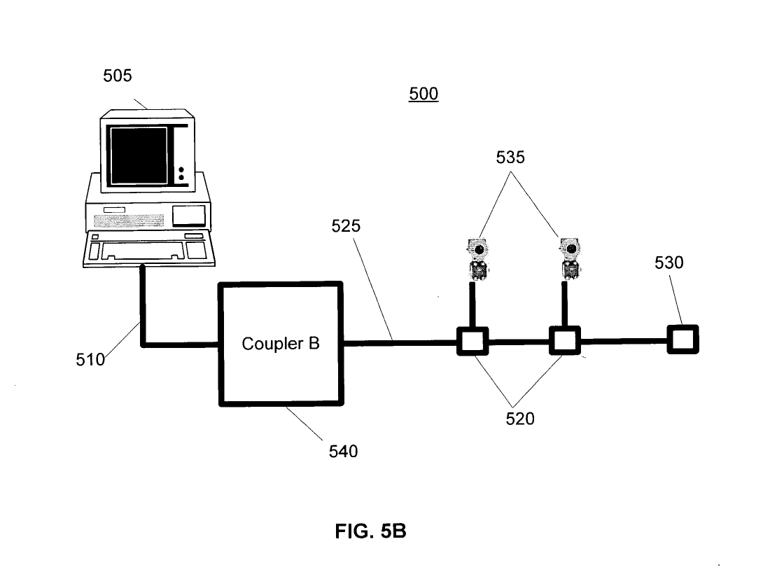

Referring to FIG. 5A, an embodiment of the system according to the present invention may be used to generate a layout for a fieldbus design 500. Turning back to FIG. 4, in accordance with the method 400 shown therein, the system can generate the layout for a fieldbus network in step 420. The design rules may be loaded from the database in step 410. The design rules in this exemplary implementation may include the following:

the minimum voltage at the field device terminals which ensures proper operation of a DP/PA segment coupler is 9Vdc;

typical output voltage for a Non-Ex DP/PA segment coupler is 19 Vdc;

typical output current for a Non-Ex DP/PA segment coupler is 400 mA;

all of the field devices produced by a particular manufacturer consume 12 mA each;

loop resistance for the cable type to be used, Type A (AWG 18), is 44 Ohms/Km; and

according to IEC61158-2, the maximum length for cable of this type is 1900 m, etc.

Of course, prior to step 410, it is possible for the user (or by the system) to select the particular fieldbus protocol to associate with the rules in step 410. Once this set of the design rules is provided to the system, the fieldbus design 500 can be retrieved by the logic arrangement, system and method according to the present invention in step 410. The exemplary components in this fieldbus design 500 may include a computer 505 for configuring and controlling the network, a Profibus DP segment 510 which is coupled to a Profibus PA segment 525 via a Coupler A 515 (e.g., a device used to interconnect the Profibus PA bus segments in a process automation system to the Profibus DP bus segments in a manufacturing automation system), one or more junction boxes 520 which can create bus branches to one or more Profibus PA field devices 535, and a segment terminator 530.

When this information has been established, the fieldbus network layout generation logic arrangement according to the present invention can be used to provide an optimized layout 420 for the fieldbus network. The software arrangement of the present invention may be configured to calculate the maximum number of Profibus PA devices 535 which may be coupled to a particular segment 525 of the fieldbus network. In an exemplary implementation, the following formulas may be supplied by the design rules:

N=V/(I×R)=Number of Profibus PA field devices in a segment where

I=Total current in the PA segment+FDE (fault disconnection equipment); and

R=Total Resistance

In the interest of simplicity, by reducing the reliance on the negligible impact of the FDE current term in this example and using exemplary numbers provided above, the following equation can provide the following results:

N=(19−9)/(12×10⁻³×1.9×44)=10 devices

Thereafter, the software can verify the total current for these 10 devices. In this example, the total current should preferably be lower than the maximum current from the coupler. Thus, for the case when the current for the coupler is 400 mA, the total current is as follows:

I=10×12 mA=120 mA<400 mA

Thus, in this exemplary fieldbus design, up to 10 field devices 535 may be utilized for a cable length of 1900 m, and each such device 535 may utilize 12 mA. Additionally, even if a device is connected to the bus at the most distant point from the with an adequate voltage, since the cable loss was likely considered as one of the layout design rules by the logic arrangement, system and method of the present invention.

For yet another exemplary embodiment of the logic arrangement, system and method for automatic generation of a layout for a fieldbus network, it may be possible to replace the Non-Ex DP/PA segment coupler 515 of FIG. 5A with an Ex DP/PA segment coupler B 540 of FIG. 5B. This segment coupler B 540 is a different type from the segment coupler than the segment coupler 515, and has different current and voltage characteristics. Also, a user may decide to utilize a shorter segment length for the segment 525 of 1000 m. In a conventional design process, the entire re-calculation would likely be performed again manually. However, the layout generation software arrangement, system and process of the present invention can be configured to automatically re-calculate the calculations as provided below to ensure that the design remains in compliance with the physical layer specification of the selected fieldbus protocol.

As defined in the previous example of FIG. 5A, the layout rules preferably remain the same. However, the current and voltage characteristics of this newly added Ex DP/PA segment coupler 540 can be provided to be as follows: the voltage for proper operation can be 9Vdc; typical output voltage may be 12.5Vdc; and typical output current can be 100 mA. The software arrangement, system and process may determine the maximum number of the field devices that can be connected to the given Profibus PA segment 525. The formula for voltage, current and resistance, as provided above, is

N=V/(I×R)=Number of PA field devices in a segment

Again, in the interest of simplicity and ignoring the FDE current, N can be determined as follows:

N=(12.5−9)/(12×10⁻³×1.0×44)=6 devices

Next, it is possible to verify that the total current for the bus with the associated devices is within the acceptable limits or guidelines provided in the specification of the particular fieldbus protocol. The total current should preferably be lower than the maximum current from the coupler (i.e., lower than 100 mA):

I=6×12 mA=72 mA<100 mA

Therefore, as confirmed by the calculations for the exemplary fieldbus network design according to the design rules, e.g., up to six (6) field devices may be coupled to the bus in a cable length of 1000 m, and such devices would likely utilize a current of 72 mA from the coupler. Thus, the software arrangement, system and method of the present invention has compensated for possible cable loss.

The user can then determine that, e.g., another of the devices should be removed and replaced with a new device that consumes more current. Again, it is possible to automatically perform the necessary re-calculations in accordance with the physical layer specification when the fieldbus design is modified. Thus the fieldbus design is established as per the physical layer specification for the selected fieldbus protocol. Additionally, the software arrangement, system and method of the present invention may provide a complete automatic generation of the fieldbus network layout. According to still another embodiment of the present invention, the user may manually place equipment in the design. In such manual mode, the software arrangement, system and method of the present invention may be configured to monitor the user's manual layout of the fieldbus network, and generate warnings or indications when the fieldbus network design does not conform with the physical layer specification for the selected type of the fieldbus network.

In a further exemplary embodiment of the present invention, when the calculations that are relevant to the number of field devices coupled to each segment of the fieldbus are performed, it is possible to distribute the fieldbus cable for the fieldbus network layout. Thus, additional topology design rules may be considered. For example, the logic arrangement, system and method of the present invention may consider the locations for any of the field devices, and accordingly determine which type of the topology can be most efficient (i.e., star, bus, tree, etc.) for the already-present locations. To make such determination, a variety of computations may be performed. Table 1 below provides a set of exemplary design rules for determining how many trunks and spurs can be used in such design, in addition to their exemplary maximum lengths.

TABLE 1
Spur Rules

| Number of spurs | 1 device | | 2 devices | | 3 devices | | 4 devices | |
|---|---|---|---|---|---|---|---|---|
| 25-32 | 1 | m | 1 | m | 1 | m | 1 | m |
| 19-24 | 30 | m | 1 | m | 1 | m | 1 | m |
| 15-18 | 60 | m | 30 | m | 1 | m | 1 | m |
| 13-14 | 90 | m | 60 | m | 30 | m | 1 | m |
| 1-12 | 120 | m | 90 | m | 60 | m | 30 | m |

The logic arrangement, system and method of this exemplary embodiment of the present invention may utilize the design rules of Table 1 to generate the fieldbus network layout, such that the cable length may be reduced, and the speed for communications purposes improved. Every branch in the fieldbus in this embodiment can be considered a spur, and each can preferably be carefully reviewed when generating the fieldbus network layout. Additionally, depending on the selected topology, the placement of unction boxes may also be determined. For example, if it is determined that the most efficient topology for the given fieldbus network design is a tree topology, a junction box is likely best mounted centrally among the devices to avoid wire extensions whose lengths exceed the limits provided in Table 1.

It should be understood that additional design rules may be implemented in this exemplary embodiment of the present invention, which may originate from the physical layer specification for the selected fieldbus protocol, and possibly from generally accepted design principles. The list of design rules may include the following:

for spurs longer than 120 m, the bus terminator should be moved to incorporate the spur into a part of the trunk;

for intrinsically safe installations, the spur length should not exceed 30 m;

for portions of the cable that have no shielding, or where the conductors are not twisted in the cable, those portions of the wire runs should be reduced to a length which is either less than 2% of the total cable length, or 8 m, whichever is shorter;

fieldbus signals should be isolated from non-fieldbus signals and other potential noise sources;

to reduce electromagnetic induction, power, frequency inverters, motor cables, and heavy electrical loads and drivers should be contained in separate guides and trays;

in order to minimize noise, at least 90% of the total length of the bus should be shielded, or at least metallic guides should be used to reduce noise;

if the tool determines that the environment is particularly noisy, it may recommend that additional capacitive grounding be used to ensure that only high frequency signals are grounded; and

shields of the spurs and trunks should be coupled; and terminators should be used for any repeaters; etc.

As illustrated by this exemplary list, there can be a very large number of design rules which may be utilized, and their number may vary depending on the type of the fieldbus protocol selected and other factors. These rules may be obtained from a variety of sources. Based on these rules, it is possible to route wire extensions efficiently, and determine the best locations for junction boxes, pass-through boxes, terminators, and other equipment.

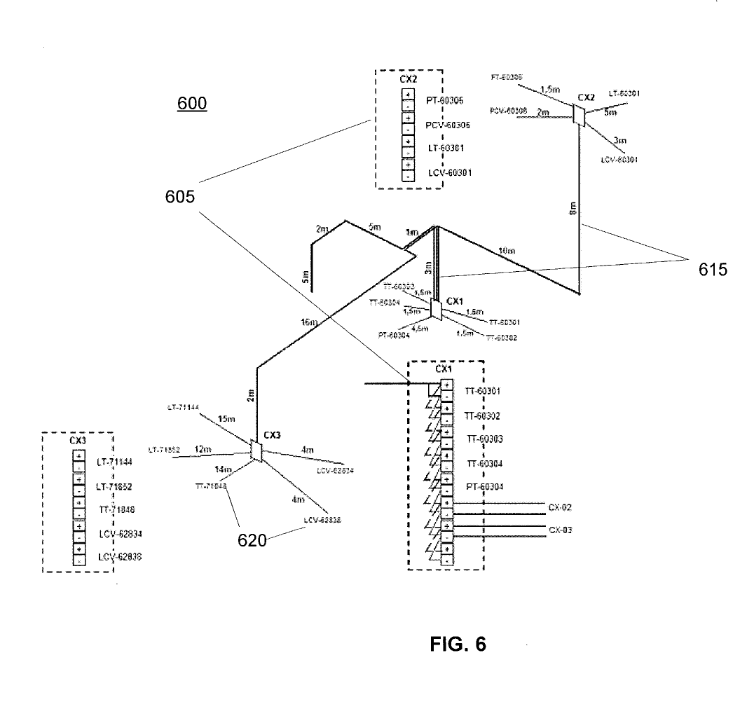

Additionally, the receipt of the user-created fieldbus designs for which a layout will be generated can be effectuated in different ways. For example, the fieldbus design may be retrieved in a CAD-type format as depicted in FIG. 6. Referring to FIG. 6, an exemplary fieldbus network design 600 defines the junction boxes 610 (shown in an expanded view 605) and the field devices 620, and additionally provides the approximate wire extension distances 615 between the mounted field devices. The software arrangement, system and method of the present invention can provide an optimized layout of this design, and can automatically place the field devices, junction boxes, panels and marshalling trays within the fieldbus network to optimize the fieldbus design of the network.

In this exemplary embodiment of the present invention, the user may also provide additional information regarding the environment of the installation site, including the locations of areas which are particularly susceptible to electromagnetic noise, areas that contain certain important power limitations and required mounting locations for particular field devices. With this type of information, the software arrangement, system and method of the present invention may be configured to, for example, re-route the bus around areas with high electromagnetic interference, or recommend the use of a better shielded cable for use in the wire run through the identified area. Again, this information may be presented to the software arrangement, system and method of the present invention in a variety of formats or files which may also provide, among other things, information concerning the current and voltage limits for the devices, and the number and types of the function blocks.

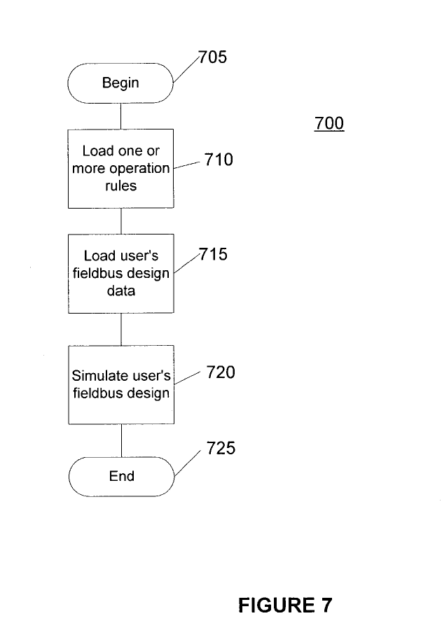

FIG. 7 shows another exemplary embodiment of the method 700 according to the present invention which can simulate the operation of the particular fieldbus network design. In step 710 one or more operation rules can be loaded for use with the particular fieldbus protocol. These operation rules may be provided to the fieldbus simulation logic arrangement, system and method of the present invention in a variety of ways. For example, the selected fieldbus network protocol may not necessarily be known, and thus the user may manually provide the operation rules in some particular format. In yet another exemplary embodiment of the present invention, the database may be used which contains predefined operation rules for a plurality of known fieldbus network protocols. Additionally, if the user specifies a new type of fieldbus network protocol which is not listed in the database, or chooses to simulate the fieldbus network which utilizes a customized fieldbus protocol, the new settings may be stored in the database for future use.

Once the fieldbus protocol operation rules are loaded, the user may then provide the fieldbus network design to be simulated in step 715. The logic arrangement, system and method of the present invention can then simulate the operation of the fieldbus network design or portion of the fieldbus network design in step 720 which can then be provided by the user. It may also be possible to implement the software arrangement and system of the present invention to automatically detect which type of the fieldbus protocol is to be used based on the fieldbus network design provided for the simulation by the user. When it is determined which fieldbus network protocol is to be utilized in the simulation, it is possible to determine which fieldbus operation rules are appropriate for the use with the loaded fieldbus network design, and may automatically load the fieldbus operation rules from a database (in step 710), thus possibly eliminating or reducing the need for the user interaction in performing step 710.

As previously indicated the fieldbus design to be simulated may be provided in a variety of formats. In one exemplary embodiment, the user may provide a series of function blocks in predefined computer files including “cff” files (capabilities files for Foundation fieldbus) and “gsd” files (device master data files for Profibus).

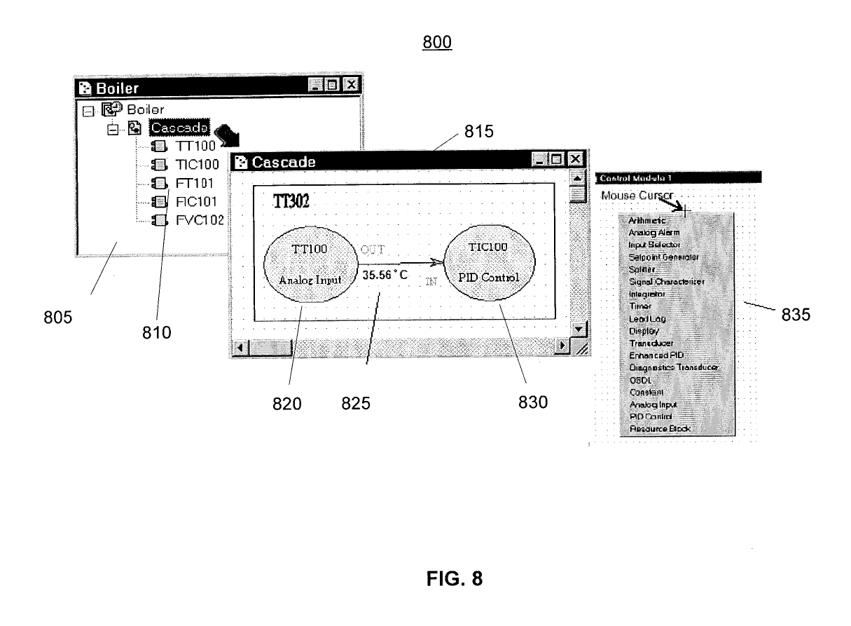

FIG. 8 shows an exemplar screen display 800 generated by an exemplary embodiment of the software arrangement, system and method of the present invention for simulating fieldbus designs. In this example, a screen 805 for the control strategy configuration of a boiler is provided. A plurality of field devices 810 are also included in this display 800. Another strategy window view 815 depicts the inputs and outputs between the field devices 810, and function block views 820 and 830 of the function blocks within the field devices 810. A menu 835 identifies the various functions that may be performed by the user. For example, the user provided a sample value 825 of 35.56 degrees Celsius as an output from the function block 820 and as an input to the function block 830. The operation of the devices may then be simulated based on this sample value by using the operation rules provided for the selected fieldbus protocol. While such operation provides an additional way to verify for the proper configuration of the fieldbus network, this operation also enables the user to design strategies for control loops (such as those depicted in FIG. 8) with an improved efficiency.

In yet another exemplary embodiment of the present invention, the logic arrangement, system and method for layout generation and simulations can be linked to operate together in real time. For example, when simulating the designed network shown in FIG. 8, the user may choose to modify the current fieldbus design by manually dragging and dropping additional field components into the simulation design window, and linking new function blocks thereto. The arrangement, system and method may also be configured to monitor the design, and continuously verify the fieldbus design against the layout design rules which were previously provided for the particular fieldbus protocol. If any deviation from the physical layer specification is detected, an indication or warning can be issued to the user. In another exemplary embodiment of the present invention which links the fieldbus simulation and network layout generation software arrangements, systems and methods in real time, the simulation functionality may be incorporated into the design and layout software arrangement and system, such that similar fieldbus networks which configured differently may be simulated in order to determine which fieldbus network layout operates most efficiently.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

What is claimed is:

1. A method for generating a layout for a fieldbus network, comprising the steps of:
obtaining at least one fieldbus network design rule for use with the fieldbus network;
obtaining data associated with one or more components of the fieldbus network; and
automatically generating an association of the components based on the data and the at least one fieldbus network design rule.

2. The method of claim 1, wherein the one or more components are at least one of a field device, a transmission line segment, a power supply, a trunk, a spur, a junction box, a pass-through box and a coupler.

3. The method of claim 1, wherein the at least one fieldbus network design rule is obtained from a database.

4. The method of claim 1, wherein the association of the components includes a fieldbus network layout.

5. The method of claim 1, wherein the data includes a block-level design for a fieldbus network.

6. The method of claim 1, further comprising the step of selecting a protocol for the fieldbus network, wherein the at least one fieldbus network design rule is based on the protocol.

7. The method of claim 1, wherein the at least one fieldbus network design rule is based on a standard for a protocol of the fieldbus network.

8. The method of claim 7, wherein the protocol of the fieldbus network is Foundations Fieldbus protocol.

9. The method of claim 7, wherein the protocol of the fieldbus network is Profibus PA protocol.

10. The method of claim 7, wherein the protocol of the fieldbus network is at least one of a Hart protocol, an Interbus protocol and a Controller Area Network protocol.

11. A method for simulating an operation of a fieldbus network, comprising the steps of:
obtaining at least one fieldbus network operation rule for use with the fieldbus network;
obtaining data associated with one or more components of the fieldbus network; and
simulating the operation of the fieldbus network in accordance with the at least one fieldbus network operation rule and the data.

12. The method of claim 11, wherein the one or more components are at least one of a field device, a transmission line segment, a power supply, a trunk, a spur, a junction box, a pass-through box and a coupler.

13. The method of claim 11, wherein the at least one fieldbus network operation rule is obtained from a database.

14. The method of claim 11, wherein the association of the components includes a fieldbus network layout.

15. The method of claim 11, wherein the data includes a block-level design for a fieldbus network.

16. The method of claim 11, further comprising the step of selecting a protocol for the fieldbus network, wherein the at least one fieldbus network operation rule is based on the protocol.

17. The method of claim 11, wherein the at least one fieldbus network operation rule is based on a standard for a protocol of the fieldbus network.

18. The method of claim 17, wherein the protocol of the fieldbus network is Foundation Fieldbus protocol.

19. The method of claim 17, wherein the protocol of the fieldbus network is Profibus PA protocol.

20. The method of claim 17, wherein the protocol of the fieldbus network is at least one of a Hart protocol, an Interbus protocol, and a Controller Area Network protocol.

21. A system for generating a layout for a fieldbus network, comprising:
a processing arrangement operable to execute the following instructions:
obtain at least one fieldbus network design rule for use with the fieldbus network,
obtain data associated with one or more components of the fieldbus network, and
automatically generate an association of the components based on the data and the at least one fieldbus network design rule.

22. The system of claim 21, wherein the one or more components are at least one of a field device, a transmission line segment, a power supply, a trunk, a spur, a junction box, a pass-through box, and a coupler.

23. The system of claim 21, wherein the at least one fieldbus network design rule is obtained from a database.

24. The system of claim 21, wherein the association of the components includes a fieldbus network layout.

25. The system of claim 21, wherein the data includes a block-level design for a fieldbus network.

26. The system of claim 21, wherein the processing arrangement is further operable to select a protocol for the fieldbus network, wherein the at least one fieldbus network design rule is based on the protocol.

27. The system of claim 21, wherein the at least one fieldbus network design rule is based on a standard for a protocol of the fieldbus network.

28. The system of claim 27, wherein the protocol of the fieldbus network is Foundation Fieldbus protocol.

29. The system of claim 27, wherein the protocol of the fieldbus network is Profibus PA protocol.

30. The system of claim 27, wherein the protocol of the fieldbus network is at least one of a Hart protocol, an Interbus protocol and a Controller Area Network protocol.

31. A system for simulating the operation of a fieldbus network, comprising:
a processing arrangement operable to execute the following instructions:
obtain at least one fieldbus network operation rule for use with the fieldbus network,
obtain data associated with one or more components of the fieldbus network, and
simulate the operation of the fieldbus network in accordance with the at least one fieldbus network operation rule and the data.

32. The system of claim 31, wherein the one or more components are at least one of a field device, a transmission line segment, a power supply, a trunk, a spur, a junction box, a pass-through box and a coupler.

33. The system of claim 31, wherein the at least one fieldbus network operation rule is obtained from a database.

34. The system of claim 31, wherein the association of the components includes a fieldbus network layout.

35. The system of claim 31, wherein the data includes a block-level design for a fieldbus network.

36. The system of claim 31, wherein the processing arrangement is further operable to select a protocol for the fieldbus network, and wherein the at least one fieldbus network operation rule is based on the protocol.

37. The system of claim 31, wherein the at least one fieldbus network operation rule is based on a standard for a protocol of the fieldbus network.

38. The system of claim 37, wherein the protocol of the fieldbus network is Foundation® Fieldbus protocol.

39. The system of claim 37, wherein the protocol of the fieldbus network is Profibus PA protocol.

40. The system of claim 37, wherein the protocol of the fieldbus network is at least one of a Hart protocol, an Interbus protocol and a Controller Area Network protocol.

41. A logic arrangement for generating a layout for a fieldbus network, which, when executed by a processing arrangement, is operable to perform the steps of:
obtaining at least one fieldbus network design rule for use with the fieldbus network;
obtaining data associated with one or more components of the fieldbus network; and
automatically generating an association of the components based on the data and the at least one fieldbus network design rule.

42. The logic arrangement of claim 41, wherein the one or more components are at least one of a field device, a transmission line segment, a power supply, a trunk, a spur, a junction box, a pass-through box and a coupler.

43. The logic arrangement of claim 41, wherein the at least one fieldbus network design rule is obtained from a database.

44. The logic arrangement of claim 41, wherein the association of the components includes a fieldbus network layout.

45. The logic arrangement of claim 41, wherein the data includes a block-level design for a fieldbus network.

46. The logic arrangement of claim 41, wherein the processor is further operable to select a protocol for the fieldbus network, wherein the at least one fieldbus network design rule is based on the protocol.

47. The logic arrangement of claim 41, wherein the at least one fieldbus network design rule is based on a standard for a protocol of the fieldbus network.

48. The logic arrangement of claim 47, wherein the protocol of the fieldbus network is Foundation® Fieldbus protocol.

49. The logic arrangement of claim 47, wherein the protocol of the fieldbus network is Profibus PA protocol.

50. The logic arrangement of claim 47, wherein the protocol of the fieldbus network is at least one of a Hart protocol, an Interbus protocol and a Controller Area Network protocol.

51. A logic arrangement for simulating an operation of a fieldbus network, which, when executed by a processing arrangement, is operable to perform the steps of:
obtaining at least one fieldbus network operation rule for use with the fieldbus network;
obtaining data associated with one or more components of the fieldbus network; and
simulating the operation of the fieldbus network in accordance with the at least one fieldbus network operation rule and the data.

52. The logic arrangement of claim 51, wherein the one or more components are at least one of a field device, a transmission line segment, a power supply, a trunk, a spur, a junction box, a pass-through box and a coupler.

53. The logic arrangement of claim 51, wherein the at least one fieldbus network operation rule is obtained from a database.

54. The logic arrangement of claim 51, wherein the association of the components includes a fieldbus network layout.

55. The logic arrangement of claim 51, wherein the data includes a block-level design for a fieldbus network.

56. The logic arrangement of claim 51, wherein the processor is further operable to select a protocol for the fieldbus network, and wherein the at least one fieldbus network operation rule is based on the protocol.

57. The logic arrangement of claim 51, wherein the at least one fieldbus network operation rule is based on a standard for a protocol of the fieldbus network.

58. The logic arrangement of claim 57, wherein the protocol of the fieldbus network is Foundation Fieldbus protocol.

59. The logic arrangement of claim 57, wherein the protocol of the fieldbus network is Profibus PA protocol.

60. The logic arrangement of claim 57, wherein the protocol of the fieldbus network is at least one of a Hart protocol, an Interbus protocol and a Controller Area Network protocol.
